(19) United States
(12) Patent Application Publication
(10) Pub. No.: US 2024/0112102 A1
(43) Pub. Date: Apr. 4, 2024

(54) SYSTEM AND METHOD FOR PROVIDING STAFFING SERVICES

(71) Applicant: Dafne Isasi, San Jose, CA (US)

(72) Inventor: Dafne Isasi, San Jose, CA (US)

(21) Appl. No.: 18/356,512

(22) Filed: Jul. 21, 2023

Related U.S. Application Data
(60) Provisional application No. 63/411,171, filed on Sep. 29, 2022.

(51) Int. Cl. G06Q 10/0631; G06Q 10/0637

(52) U.S. Cl. CPC G06Q 10/063112; G06Q 10/06375

(57) ABSTRACT

A staffing service facility for recruitment of aviation personnel on planned flight itineraries. The facility collects information from applicants and stores them in a database. In a web-based computer implementation of the staffing service facility, a paywall separates free content from paid content. A user interacts with the facility to find satisfactory candidates with available positions. The user accesses free content available on each of the candidates identified in the search results, including a multi-media content distinguishing the candidates. Upon selection of provisional crew members, the user navigates the paywall, which includes executing a contract and making a deposit of funds into escrow. Where the escrow funds are based on a calculation of the compensation costs attributable to the provisional crew list and the assessment of a fee derived from this compensation amount. At the end of the process, the user makes a final disposition of each candidate to hire.

### FIELD OF THE INVENTION

The present invention relates generally to staffing services, and more particularly, to a system and method that includes a computer-readable medium configured to facilitate the recruitment of candidates to meet the staffing requirements of unique services. For instance, staffing related positions in the aviation, yachting, modeling, or private assistant sector.

### BACKGROUND OF THE INVENTION

The aviation industry in the United States comprises several different sectors, broadly divided into the civilian and military groups. The civilian side is generally divided between commercial aviation and general aviation. Commercial aviation typically involves scheduled flights and provides the fee-for-service transport of cargo and/or passengers. For example, regional and major airlines, such as Delta, Southwest, American, and SkyWest, are some of the scheduled air carriers or legacy carriers for transporting passengers. Cargo transport operators include entities such as FedEx or UPS. General aviation, by contrast, involves personal transport or business transport that does not use an airline. General aviation flights typically require more flexibility than the airlines can offer, especially in scheduling. Examples of general aviation flights include ambulance operations (e.g., emergency medical evacuations), the transport of medical goods or humanitarian aid, airborne law enforcement, forestry applications (e.g., firefighting), and crop spraying (e.g., farming and agriculture purposes). Another area of general aviation is business or private flights, which can involve a general private jet company (e.g., chartering service) or a private jet owner. For example, corporate operations may employ a company-owned or privately-owned aircraft to fly business partners for corporate reasons, e.g., to visit clients in another city. General aviation extends across a diverse range of situations, including charter flights, owner-operated private flights, and corporate or business-oriented flight operations.

The Federal Aviation Administration (FAA) provides a regulatory framework for each aviation class, using fee-for-service as one primary factor to distinguish one class from another. The pertinent part of the FAA guidelines is documented in the Federal Aviation Regulations (FAR), specifically parts 91, 121 and 135. Part 121 is the most restrictive of the three parts and is considered the highest commercial air travel safety standard. The standards of part 121 apply to the scheduled air carriers, the ones transporting persons and cargo for compensation. Part 91, by comparison, is the least restrictive of the three parts of the FAR concerning aircraft operations. Part 91 includes general aviation regulations and general flight operating rules, such as crew rest and duty and aircraft operations within certain weather conditions. General aviation operations fall into this part 91 category.

All airliner operators observe the regulations of part 91 unless a more restrictive regulation applies (e.g., part 135). One example of a part 91 operator is a private jet owner flying with friends or family. Part 91 operators are effectively prohibited from accepting anything of value as compensation for flying passengers or cargo, allowing compensation for air transportation only in a minimal set of circumstances. In a part 91 setting, the pilot-in-command (PIC) has operational control of the flight operations and assumes ultimate responsibility of the safety of a flight. As such, part 91 governs situations where the pilot is directly responsible for the entire private aircraft. Part 91 operators represent a unique situation from a staffing perspective, especially compared to operators in the other aviation classes.

Part 135 operators represent a hybrid situation. Part 135 provides regulations for commuter operations and on-demand operations, also known as charters. This category includes private jets, small turbo-propeller aircraft, and commercial helicopters. Certification as a part 135 operator enables one to operate as a non-scheduled air charter carrier, such as on-demand jet charters. Part 135 certificate holders can conduct on-demand operations, which may include limited scheduled operations, or scheduled (commuter) operations, which allow unlimited scheduled operations as well as on-demand operations. The on-board, aircraft staffing typically includes the aircrew (flight crew) and the cabin crew. The flight crew is responsible for operating the aircraft and includes various flightdeck personnel or positions in an ordered ranking, including, for example, the captain, first officer (co-pilot), second officer, flight engineer, and navigator. The composition of the flight crew can vary depending on the type of aircraft, the duration of the flight, and the purposes of the flight. The cabin crew attends to the passengers. The cabin crew is under the authority of the flight crew and operates outside the cockpit. The cabin crew members can include a purser, one or more flight attendants, flight medic (for air ambulance flights), and a loadmaster (for cargo aircraft).

The on-board, aircraft staffing for part 121 operators exhibits a fairly stable situation. Flight crew and cabin crew are typically employees of the airline or carrier. The flight crew, for example, may be unionized. The airline company will typically have a human resources department that facilitates the recruitment, hiring, and staffing services for the organization. Part 91 operators, by comparison, do not have comparable staffing requirements, instead operating on a generally unscheduled, on-demand basis. In an owner-operated and owner-manned aircraft flown for private purposes (i.e., no compensation for cargo and/or passenger transport), the owner/pilot constitutes the aircrew staff. No additional on-board personnel is needed or required. The situation is different, though, for part 135 operators. Consider the scenario of a chartered jet. Charter services typically own a fleet of jet aircraft qualified for operation by part 135 certificate holders. Charter companies, however, typically employ the on-board aircraft personnel as regular, full-time employees to save on costs because contract workers in the long run end up costing the carter company more. It is desirable, however, that the charter companies hire aircrew and cabin crew on an as-needed, on-demand basis depending on the demand and the flight under consideration. This way, the personnel are hired on a per flight basis as independent contractors. The use of independent contractors may be economical from the standpoint of cost savings relating to employee-based benefits (i.e., independent contractors typically do no receive benefits beyond compensation for services), but a staffing model reliant on independent contractors poses various challenges, not the least of which is the uncertainty around the timely availability of personnel, especially the aircrew.

Chartering services have the additional challenge of finding a crew tailored to the clientele they intend on serving. The clients who procure chartered flights typically expect a level of individualized and customized attention not available on other types of flights. For example, the on-board experience of a chartered flight carrying corporate clients engaged in a business deal will be different than one carrying a musical group on tour, which will be different than one carrying a sports team to a match. As these examples show, chartered flight services can be made for a single flight or for a series of flights over a certain extended duration (e.g., the length of a musical concert tour). In longer chartered flight engagements, the on-board atmosphere and environment will take on the quality of a more intimate experience as the clients spend increasing amounts of time in the company of the crew (e.g., flying from one concert destination to another). For this reason, a highly specialized and customized process is needed to match the in-flight personnel, both aircrew and cabin crew, with the tastes and preferences of the clientele and the expected ambience of the flight experience. For certain clients, priority is given to aircraft personnel who can respect the privacy and confidentiality of every aspect of the flight experience. By comparison, commercial flights on the major carriers are essentially public venues. There is no expectation of privacy in terms of preserving anonymity or remaining free from notice. A different set of expectations can apply for certain clients who want their identity and the details and circumstances of the flight to remain private. A premium is placed on the ability of the in-flight crew to honor this request for privacy. Great care, then, is undertaken to vet aircrew and cabin crew candidates who are trustworthy in this regard.

In view of the foregoing considerations, the hiring and recruitment process to staff private chartered flights has several layers of complexity. At a fundamental level, the candidate, either flight crew or cabin crew, must possess the minimum qualifications needed to professionally execute the flight. For the pilot, this means adequate credentialing and licensing, among other factors. Additionally, the staffing agent for the chartered flight service must also consider and weight various other intangible factors to evaluate a candidate's suitability and fitness, such as personality, presentation, demeanor, appearance, and attitude. In a typical recruitment process, regardless of industry, a job candidate or potential hire submits a resume. The Internet has made the task of matching job hunters with hiring firms much easier and more efficient, evident in the emergence of employment-oriented websites. A job seeker can use a job listing service hosted on a served-based resource, such as the Indeed company website. Visitors to the Indeed website can post their resume, search for jobs, and browse an almost endless range of employment opportunities. An employer reviews the resume, and, if a candidate passes this stage and further inquiry is needed, an interview is scheduled, either virtually or in-person. The interview is typically the first and only chance the hiring firm has to meet the candidate and assess their personal qualities. For some industries and jobs, this traditional approach, which combines an impersonal review of written, documented credentials with a single personal interview, may be sufficient. However, in highly client-centric work settings, in which the staff interacts regularly and personally with a diverse range of clients, the conventional approach lacks adequate opportunities to evaluate the intangible, personalized aspects of a job candidate. The lack of any such highly personalized component makes traditional hiring practices unsuitable for the staffing needs of private chartered flight services. A different type of hiring practice, which values the importance of individual qualities and personality traits that cannot be readily reflected in a document like a resume, is needed.

Some corporate or business entities partner with a staffing agency to help in the candidate search. In this framework, the human resource department outsources its hiring responsibilities to a third-party, staffing agency. The expectation behind such a move is that the recruiters at the staffing agency have more specialized, industry-specific hiring experience than the general practitioners typically found in most corporate human resources departments. The staffing service is an organization that matches companies and job candidates, enhancing the ability to make connections with multiple hiring managers looking to find the right people for their job openings. However, a staffing agency faces the same challenges and difficulties encountered by in-house hiring managers. While a recruiter may have the advantage of knowing better where to look for and identify suitable candidates, based on their in-depth work in the field, recruiters employ basically the same process to screen candidates in the hiring process. First, resumes are screened based on the job's minimum or mandatory qualifications. The screening process may require the applicant to fill out an employment application. Second, resumes are screened based on the job's preferred qualifications. This two-part screening process is based almost exclusively on a review of the documentary record (e.g., resume, letters of reference, examples of work product), reviewing qualifications such as work experience, education, skills and knowledge, and competencies. The result is a shortlist of candidates who move onto the interview phase, which is typically the first and only opportunity to meet the candidate in person and evaluate the candidate's fitness from a personality standpoint. In view of the foregoing, the current model for a staffing service is not suitable to meet the staffing needs required in the selection of a crew for private chartered flight services.

The staffing needs of general private jet companies, such as chartered air services certified as part 135 operators, offer probably the clearest example of the deficiencies in traditional recruitment methods. The diverse clientele served by chartered jet services typically requires a robust recruitment and staffing operation that is customized, personalized, adapted, and otherwise tailored to the peculiarities, preferences, uniqueness, and distinctiveness of each charter flight experience. Each chartered flight is singular and different and has its own unique identity that influences the selection of the flight crew and cabin crew. A match between crew and client is not, however, limited to chartered services. A level of fitness is also demanded by private jet owners who do not man their own aircraft but instead prefer to hire a crew, a category of part 91 operators. A private jet owner, for example, may typically use the aircraft to fly family, friends, colleagues, and close associates for a variety of reasons, such as pleasure trips, vacation, recreation, and private business matters. The private jet owner will want to hire a crew deemed trustworthy to handle this type of venture. Again, the more limited screening available in traditional recruitment practices, which lack an in-depth exploration of a candidate's personal attributes outside of an interview, makes conventional staffing methods unsuitable.

Accordingly, there is need for a solution to at least one of the aforementioned problems. For instance, there is an established need for a robust, diverse, multi-faceted, multi-layered, and dynamic staffing service that can offer the highly personalized and customized approach involved in the hiring of aircraft personnel. There is a particular need for an enhanced staffing service to provide the recruitment and hiring needs of general private jet companies and private jet owners, especially those who operate and support private chartered flight services and other general aviation flights under the requirements of FAR part 91 and part 135.

### SUMMARY OF THE INVENTION

The present invention is directed to staffing services. In one exemplary form, to the invention is directed to an aviation staffing service useful to recruit and hire candidates and/or applicants for positions as members of the flight crew and/or cabin crew to fill vacant job opportunities pertaining to a planned flight itinerary or scheduled booking. However, it should be readily understood that the instant invention may be utilized to staff crew in the yachting industry, models in the modeling industry, and the like. In the exemplary embodiments shown, the staffing service is particularly useful to operators governed by part 91 and/or part 135 of the Federal Aviation Regulations. The staffing service, in various implementations, can be variously embodied as a system, method, and computer-readable medium having processor-executable programming instructions. In one form, the staffing service is implemented in a web-based design, such as a website. A user can access the features of the staffing service in multiple ways, including a mobile application via a portable communication device (e.g., mobile phone or tablet) and/or a web browser via a computer device (e.g., laptop or desktop). The app-based and browser-based access provides versatile flexibility to the user. A database is compiled including profiles of individual candidates and/or applicants. The staffing service website/app includes an applicant portal for candidates to enter and submit information, which is then used to build the candidate profile. The profile offers a multimedia presentation of the candidate and the qualifications of the candidate. The profile includes, but is not limited to, a resume, up to three multi-media images or files, video responses made by the candidate in response to a set of queries, uploaded documents to verify credentials, and other credentialing information. A user, such as a staffing agent tasked to reserve a crew for an upcoming flight plan, engages and interacts the staffing service in a multi-stage process including a paywall transition. A soft paywall grants the user access to free content in front of the paywall and grants the user access to paid content behind the paywall.

At the front end, the user employs a filter mechanism such as a search engine tool to identify suitable candidates based on a set of search criteria. The search engine accesses the candidate profile database and automatically generates search results compiled as a hit list of candidates based on assigned values to the candidate profile satisfying the search criteria. The filter can be tuned further and reapplied if the user decides to parse the search results even more. The user evaluates the candidates identified in the search results and makes a determination on each candidate. When the candidate provides information, the information is provided in a non-standardized format. After a search is performed, however, the information appears to the user in a standardized format. Namely, to provide information that is decrypted and avoid providing information that is encrypted. The user makes a provisional or pre-selection of a crew list. Pre-selection of a crew member includes a physical marker on the crew profile. For instance, a pre-selected crew member may include a green border marking around its profile. Conversely, a rejected crew member may include a red border marking around its crew profile. The members who compose this provisional crew list can have different levels of interest expressed by the user. Membership on the provisional crew list reflects an indication that the user desires further examination of the candidate based on information accessible or retrievable behind the paywall. The provisional or pre-selection of the crew list represents a tentative commitment contingent on a further examination of the candidate and the rendering of a final determination following additional phases of the recruitment process, such as an interview.

To proceed further in the recruitment process, the user navigates a paywall. Once the provisional crew selection is made, a calculation is made of the compensation cost to hire the members of the provisional crew. Based on this compensation cost, a fee is automatically calculated and this amount is put into escrow. This escrow deposit or payment is part of the paywall. As an additional part of the paywall, the user also executes an agreement, which stipulates that the user will not misuse or misappropriate the information from the staffing service website/app and use it for unauthorized recruitment and hiring purposes, without going through the staffing service facility and paying the necessary fee. Once the user navigates the paywall, the user has full access to the entire profile record of the selected candidates. The paid content includes, among other things, contact information on each candidate, which the user employs to contact each candidate and schedule an interview. After the entire screening and vetting process is complete, including the interview, the user proceeds to making hiring decisions. In particular, the user makes a final determination regarding the disposition of each candidate, i.e., rejection (no job offer), acceptance (job offer extended). Once the composition of the crew is settled, and the hiring is complete, the only thing left is performance of the services by the hired crew.

In one exemplary embodiment, the amount held in escrow can be adjusted based on the final composition of the hired crew. The escrow amount is returned in full, for example, if no crew member is hired. In one alternative form, if the crew is not hired the amount held in escrow may be held as credit for future transactions or returned in an alternative form (e.g., digital currency). Once job performance has occurred, the escrow amount is transferred to complete the staffing transaction. The completion of job performance, for example, refers to the hired crew performing the contracted services for the planned flight itinerary. The staffing service can be used to recruit candidates for any hiring, employment, and/or contractual status, including part-time, full-time, and freelance (e.g., independent contractor).

In a first implementation of the invention, a method to provide staffing services comprises the steps of:
using a digital platform stored in a computer-readable memory and executed on at least one processor with access to one or more databases;
determining receipt of a plurality of candidate profile information in a non-standardized format that is storable on a database;
automatically, through an encryption module on the digital platform, encrypting a portion of the candidate's profile information and maintaining a portion of the candidate's profile information decrypted;
assigning, through a variable assignation module, the plurality of candidate profiles search criteria variables corresponding to the set of decrypted profile information;
generating search results of first candidate profiles satisfying the search criteria in a standardized format when searched,
   wherein the standardized format comprises of decrypted information of the first candidate profiles;
determining a first crew selection based on a first evaluation, wherein the evaluation is performed with only the decrypted information;
utilizing a gesture to select first candidates from the plurality of candidate profiles;
navigating a paywall;
automatically, by way of the digital platform, decrypting the encrypted profile information after navigating the paywall; and
determining a second crew selection based on a second evaluation based.

In a second aspect, the first information includes a resume and video responses to a set of queries. The second information includes contact information and document uploads from the candidate.

In another aspect, the first information defines free content in front of the paywall and the second information defines paid content behind the paywall.

In another aspect, the step of providing the database of candidate profiles includes a candidate making a submission comprising the first information and the second information and creating a candidate profile based on the candidate submission.

In another aspect, the step of searching the database includes the user selecting the search criteria and applying a filter to the database contents using the selected search criteria. When searching for the potential crew members, geographical location of each crew member is taken into consideration.

In another aspect, the step of first evaluating includes determining a suitability and/or fitness of each candidate in the first candidate profiles for a corresponding position as a member of a flight crew and/or cabin crew.

In another aspect, the step of determining the first crew selection includes making the first crew selection as a provisional selection contingent on a further evaluation based on paid content behind the paywall.

In another aspect, the step of navigating the paywall includes calculating a fee based on projected compensation payable to one or more members in the first crew selection upon future performance of a job under consideration and depositing an amount in escrow reflecting at least the calculated fee.

In another aspect, the step of second evaluating includes contacting at least one member in the first crew selection using contact information contained in the second information and scheduling an interview with at least one contacted member.

In another aspect, the step of determining the second crew selection includes making a disposition of each member in the first crew selection to generate a crew reservation defining the second crew selection.

In another aspect, the second crew selection is a subset of the first crew selection.

In another aspect, the method further includes executing a transaction involving withdrawal and/or transfer of funds from escrow after fulfillment of job performance obligations by one or more of the members in the second crew selection.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a block diagram illustration of a system configured to provide aviation staffing services, in accordance with a first illustrative embodiment of the present invention;

FIG. 2 presents a block diagram illustration of the various subsystems comprising the system of FIG. 1 and which implement and execute various staffing service functionalities;

FIG. 3 presents a flowchart describing in high-level detail a process configured to carry out the staffing service operations and functionalities disclosed in the systems-level illustrations of FIGS. 1 and 2;

FIG. 4 presents a flowchart describing a process executed by a job candidate to submit profile information, and which further details the operations underlying the process step in FIG. 3 relating to the build-up of the candidate profile database;

FIG. 5 presents a flowchart describing a process executed by an employer or hiring agent to make a pre-selection of candidates to fill the crew member vacancies of a planned flight, and which further details the operations underlying the process step in FIG. 3 relating to the user making a provisional selection of the crew;

FIG. 6 presents a flowchart describing a more detailed process underlying the operation in FIG. 5 relating to the user evaluation of the candidate profile;

FIG. 7 presents a flowchart describing a process executed by the hiring entity to navigate the paywall and transition from the free content side, as shown in FIGS. 5-6, to the paid content side in order to gain access to the full candidate profile, and which further details the operations underlying the process step in FIG. 3 relating to user navigation of the paywall;

FIG. 8 presents a flowchart describing a process executed by the hiring entity, now behind the paywall, to access the full profile of each selected candidate and to take steps towards making a final disposition on each candidate, and which further details the operations underlying the process step in FIG. 3 relating to the user making a final crew selection; and

FIGS. 9-21 presents a series of illustrative renderings of screenshots depicting representative aspects of a computerized, web-based, on-line implementation of the aviation staffing service shown in FIGS. 1-8.

Like reference numerals refer to like parts throughout the several views of the drawings.

### DETAILED DESCRIPTION

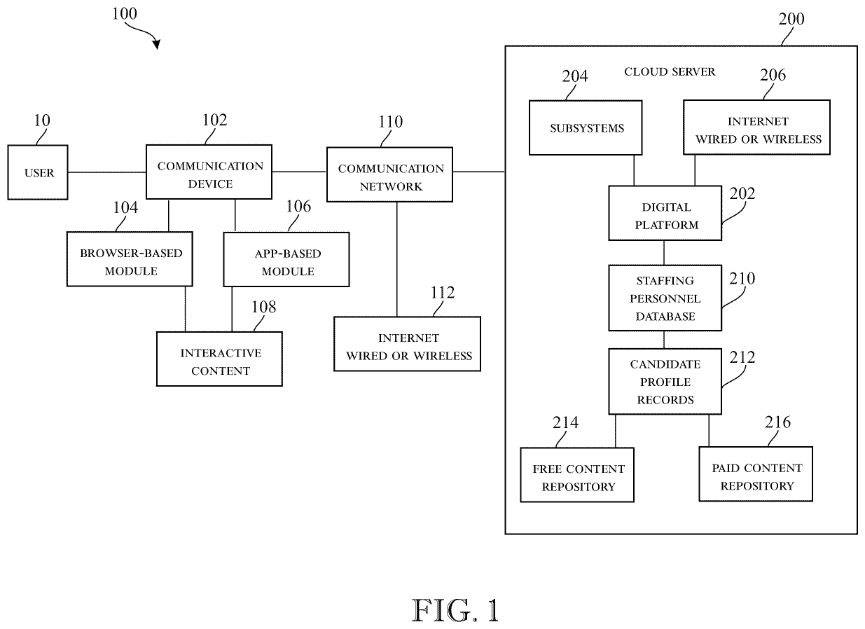

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a multi-stage, paywall-enabled, multi-media, aviation staffing facility configured as a recruitment tool to identify, screen, interview, and hire candidates and/or applicants for positions and opportunities as a member of a flight crew or cabin crew. The aviation staffing facility is especially suitable to fulfill the staffing needs of aircraft operators governed by part 91 and/or part 135 of the Federal Aviation Regulations promulgated by the Federal Aviation Administration. The facility, in one exemplary form, is implemented as a website-based technology, accessible in any number of ways, including a mobile application installed on a mobile phone and a browser located on a computer device. The facility, structured in one form as a soft paywall, offers access to free content (a subset of the complete candidate profile) to make a pre-selection of candidates, then requires navigation of a paywall to access paid content, which constitutes the full profile of each candidate.

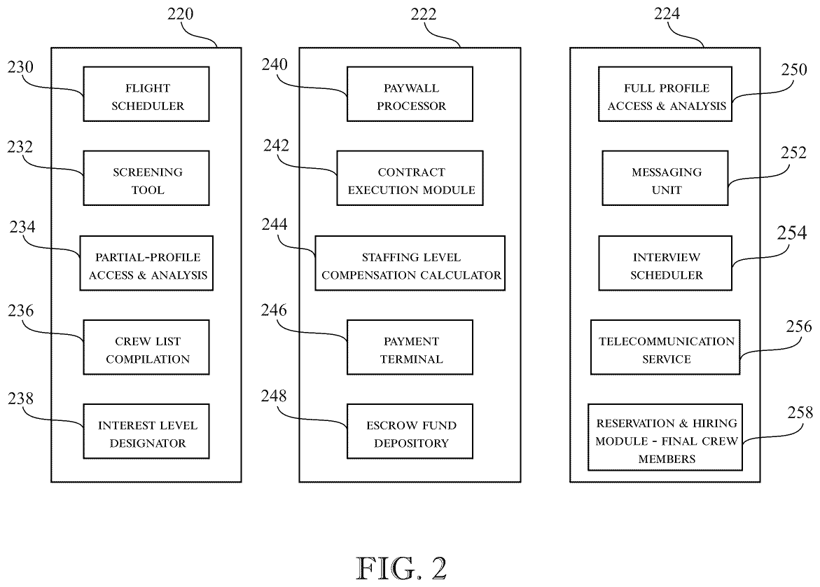

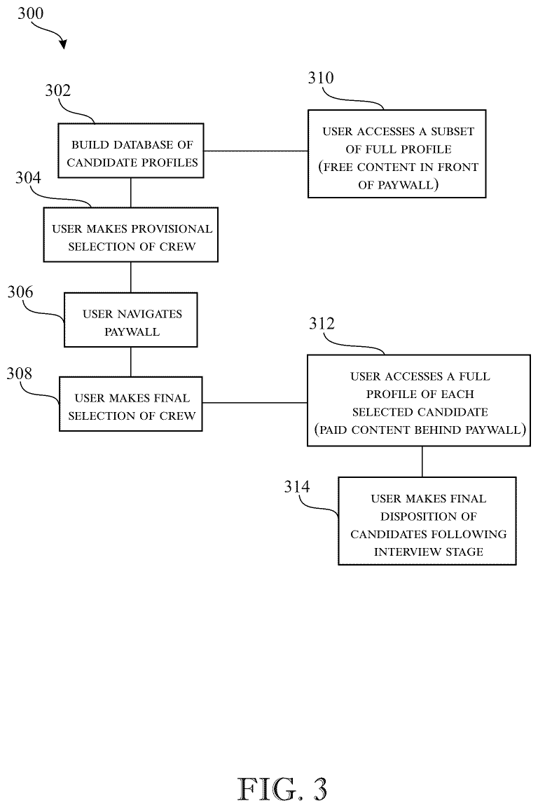

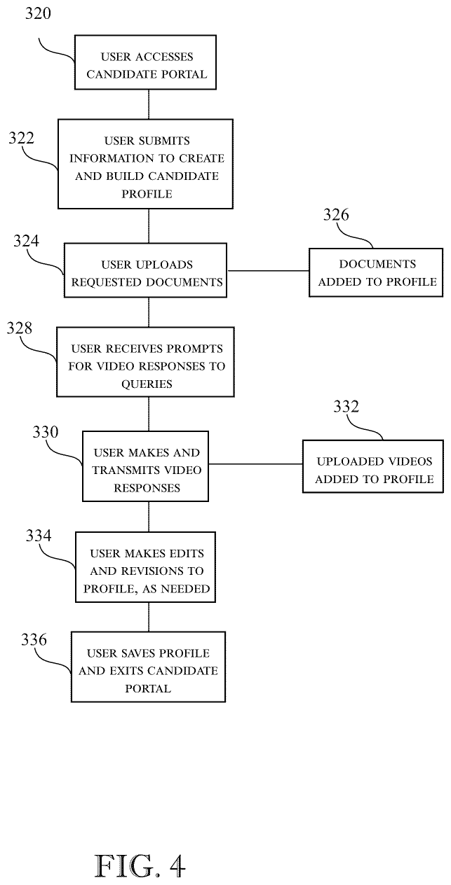

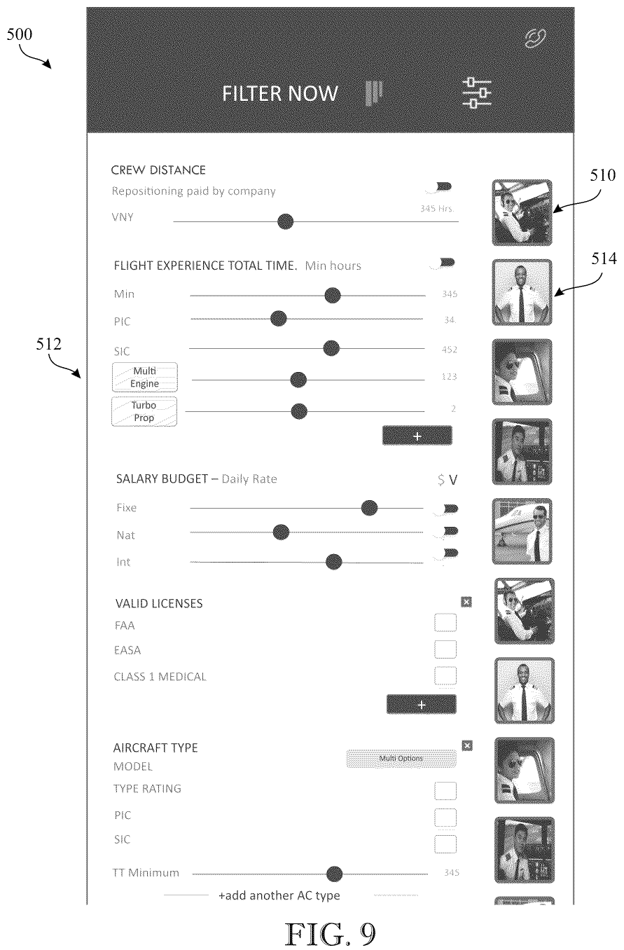

Referring initially to FIGS. 1 and 2, an aviation staffing service system 100 is illustrated in accordance with a first exemplary embodiment of the present invention. By way of overview, FIGS. 3-8 disclose a process 300 performed by system 100 of FIGS. 1 and 2. The process 300, in one exemplary form, involves a series of operations or actions performed to execute and otherwise facilitate a matchmaking, personnel recruitment and procurement service configured to meet the staffing requirements of an aviation-related enterprise. FIG. 3 provides a high-level description of the process 300, while FIGS. 4-8 elaborate features and operations of process 300 in more detail. FIGS. 9-21 disclose a series of renderings of webpages depicting various features of process 300 set forth in FIGS. 3-8 and carried out by a computer-based, web-based implementation of the system 100 shown in FIGS. 1-2.

Referring to FIG. 1, system 100 is configured to permit a user 10 to interact with a cloud-based system 200, employing a user-operated communication device 102 in communication with the cloud-based system 200 over a communication network 110. As discussed further, the cloud-based system 200 hosts the resources for implementing the process 300 disclosed in FIGS. 3-8. In one implementation, the cloud-based system 200 includes a server to resource, reside, house, provision, or otherwise host a website configured to support, implement, embody, and otherwise facilitate the process 300 disclosed in FIGS. 3-8 and for which FIGS. 9-21 represent illustrative webpages generated by the website.

The communication device 102 is preferably an electronic device and may generally comprise a handheld, portable mobile or smart phone device, tablet, lap top computer or workstation. The device 102 may include audio and video circuitry, a keyboard (physical or digital) or touchpad, memory or access to memory, one or more processors, I/O network interface, application program interface, read/write memory (RAM), read-only memory (ROM), and a visual screen or display. The device 102 is preferably internet-enabled and configured to support the download, installation, and operation of mobile applications, including the relevant APIs (Application Programming Interface). The communication device 102 is equipped with a browser-based module 104 (e.g., web browser) and an app-based module 106 (e.g., mobile application), which enables communication device 102 to access interactive content 108 (e.g., webpages) from the cloud-based system 200 over communication network 110.

The communication network 110 can provide, in one form, a wired or wireless internet connection 112. Communication network 110 may include wireless communication including but not limited to: WLAN (wireless local area network, Wi-Fi, (IEEE 802.011), WPANS (wireless personal area networks, such as Bluetooth (IEEE 802.15), Infrared, ZigBee, WMAN (wireless metropolitan area network, such as WiMax (IEEE 802.16)), WWAN (wireless wide area networks, internet), and GAN (global area network), a mobile wireless communication system, such as 3G, 4G, or 5G, and an internet protocol based communication system. The communication network 110 may also include a wired communication including but not limited to, fiber optic systems, a telephone network such as a PSTN (public standard telephone network). The communication network 110 may further include a radio frequency network (RF), a cable network, a satellite network, and an internet or intranet network, where each network is adapted for transmitting, and receiving data, information, audio, video, texts, messages, emails, and files from the electronic device 102, and cloud services system 200. It will be noted that network, interface, communication and information exchange equipment, components or peripherals may be employed, including, but not limited to, use of base stations, servers, routers, switches, repeaters, towers, antennas, Ethernet hubs, wired or wireless data pathways, modems, virtual private networks (VPN), modems, proxy servers, application program interfaces (APIs), networking adapters, or gateways. Encryption protocols may also be employed to secure the transmitted information, data, or messages. For example, a few exemplary forms of encryption include IPsec, or secure sockets layer (SSL), and symmetric or asymmetric encryption.

The cloud-based services system 200 includes, in combination, a digital platform 202, subsystems 204, staffing personnel database 210, and a wired or wireless internet connection 206 to enable communication among all of the units. The staffing personnel database 210 is populated with a file system of candidate profile records 212, which logically contains a free content repository 214 (decrypted) and a paid content repository 216 (encrypted until decryption key is provided). In this regard, the candidate profile records are received in a non-standardized format and presented to a staffing person in a standardized format, listing candidate profile information that is decrypted until the staffing person passes the pay wall. The unit 200 includes, or has accessible communication or storage capacity with, internal or external storage comprising optical disks, CD-ROM, flash memory or USB storage devices, or other machine readable medium suitable for storing computer source code. The storage facilities may include file manifests, index manifests, instructions, identifier values, data tables, look-up tables, files, data, information, or folders. It is appreciated that the digital platform 202, subsystems 204, and database 210 may be entirely included within, and made part of, the cloud services system 200. Alternatively, the digital platform 202, subsystems 204, and database 210 may be maintained in one or more separate physical or geographic locations from the cloud services system 200. Referring to FIG. 2, in one exemplary embodiment, the subsystems 204 may comprise provisional candidate selection subsystem 220, a paywall subsystem 222, and an encryption/decryption, post-paywall, paid content, final candidate selection subsystem 224. The provisional candidate selection subsystem 220 is a pre-paywall facility offering the user free content on candidate profiles (i.e., decrypted information), while the final candidate selection subsystem 224 is a post-paywall facility offering the user paid content on candidate profiles (i.e., encrypted information that is decrypted once payment is made). In particular, the provisional candidate selection subsystem 220 is logically prior or before the paywall subsystem 222, while the final candidate selection subsystem 224 is logically after or behind the paywall subsystem 222.

The cloud services system 200 includes at least one cloud-based server that may comprise one or more servers, computers, I/O and/or network interfaces, processors, memory, and necessary computer readable medium for storing, processing, operating, sharing, transferring, and receiving, data, files, videos, images, audio, and other information, and for performing computations, hosting web pages and/or applications, maintaining and communicating with databases, processing software application source cloud, and other operatives associated with software functionalities. In one exemplary embodiment, the one or more cloud-based servers may include an application server, a web server, a computing server, a communications server, a database or file server, a mail server, a proxy server, or additional servers. The cloud-based server can be managed, controlled and operated by a designated internet service provider, dedicated management, or third party. As such the server may be managed by any of an application service provider (ASP) offering on-demand software or software as a service, a network service provider (NSP), an internet service provider (ISP), a managed service provider (MSP), or a telecommunication service provider (TSP) where providers can charge an ongoing subscription or fixed fee service to users. The server memory may comprise any suitable memory technology, such as static random access memory (SRAM), synchronous dynamic RAM (SDRAM), nonvolatile/flash-type memory, or any other type of memory. Machine-executable program instructions or computer application programs associated with the software platform for implementing the process 300 may be stored on one or more machine readable mediums, including but not limited to, optical disk, magnetic or optical card or tape, flash memory, CD/DVD-ROM, memory dongle, magnetic media such as a hard drive or any other external machine-readable medium coupled to server or server computer via, I/O interface. Computer-accessible medium may include any volatile or non-volatile media such as RAM (e.g. SDRAM, DDR SDRAM, RDRAM, SRAM, etc.), ROM, EEPROM, or EPROM.

Continued reference is now made to FIGS. 1 and 2, in conjunction with FIGS. 3-8, to discuss the elements, units, and features of subsystem 204 in relation to the staffing service process 300. Referring to the high-level view of staffing service process 300 shown in FIG. 3, a facility is provided to build a database of candidate or job applicant profiles (step 302). Reference is specifically made to FIG. 4 to describe the operations to implement database construction step 302. Initially, an applicant accesses the candidate portal (step 320) of the website hosted by the cloud-based server system 200. The applicant includes, but is not limited to, individuals who can serve in the capacity of aircrew or flight crew (personnel who operate an aircraft while in flight) or cabin crew. In FIG. 1, the job applicant, as user 10, can employ electronic device 102 to access the website (interactive content 108 displayed locally) via a browser-based facility 104 or an app-based facility 106. The website can be configured at the candidate portal side to solicit and otherwise request information from the applicant. Any conventional means can be used to procure this information from the job applicant. An online employment application, for example, can serve as a standard template to query the applicant on needed information. By way of an interactive dialogue and exchange with the staffing website, the user submits the requested information to create and build the candidate profile (step 322). The user uploads requested documents, which are added to the applicant's profile (steps 324, 326). These documents include, but are not limited to, a resume, a picture of the applicant in uniform or doing other activities, certifications of qualifications (e.g., licensing credentials, transcript, diplomas), whether the candidate is looking for freelance position or full-time position, and other supplemental data. The candidate portal includes a feature to query the applicant with a series of prompts and to direct the applicant to prepare and submit video responses to these queries (step 328), and can ask that the candidate provide their geolocation. At the user side with electronic device 102, the applicant makes and transmits the video responses, which are then uploaded and added to the candidate profile (steps 330, 332). As needed, the user/applicant is given an opportunity to make edits and revisions to the individual profile (step 334). At the conclusion of this candidate onboarding process, the user/applicant saves the profile and exits the candidate portal (step 336). Referring to FIG. 1, the cloud-based system 200 stores the information collected from the job applicants via the candidate website portal in the search-enabled staffing personnel database 210. Any means known to those skilled in the art can be used to implement and organize database 210. A suitable application or program is provided to organize the collected job applicant information into an appropriate profile-style format, such as candidate profile records 212, which contains an individual candidate profile record or file for each job applicant. Within each candidate profile record, a logical division is made between free content (allocated to free content repository 214) and paid content (allocated to paid content repository 216). In particular, each candidate profile record contains one subset of information or free content that is freely accessible, and another subset of information or paid content that is marked for restricted access and which can be made available by navigating a paywall.

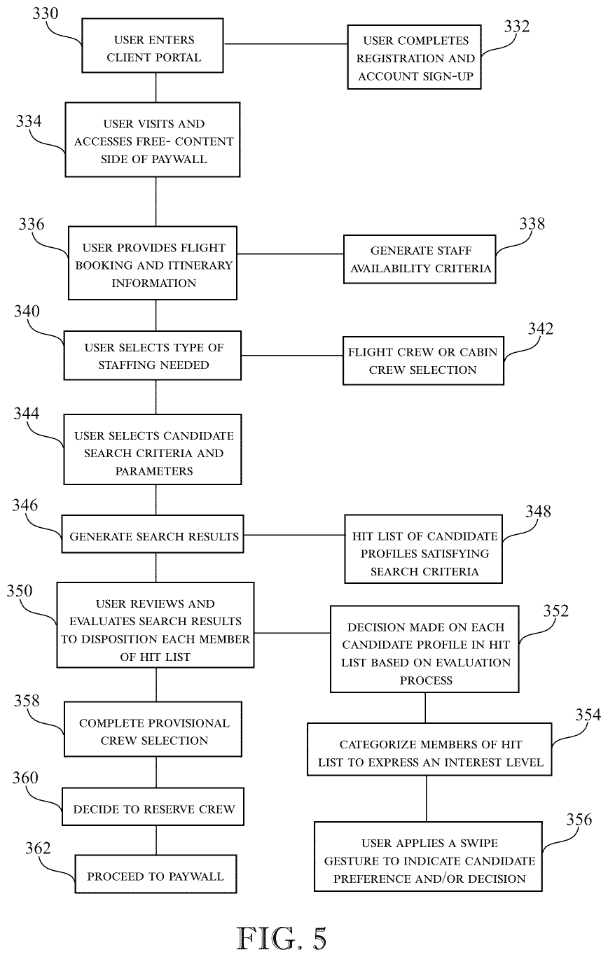

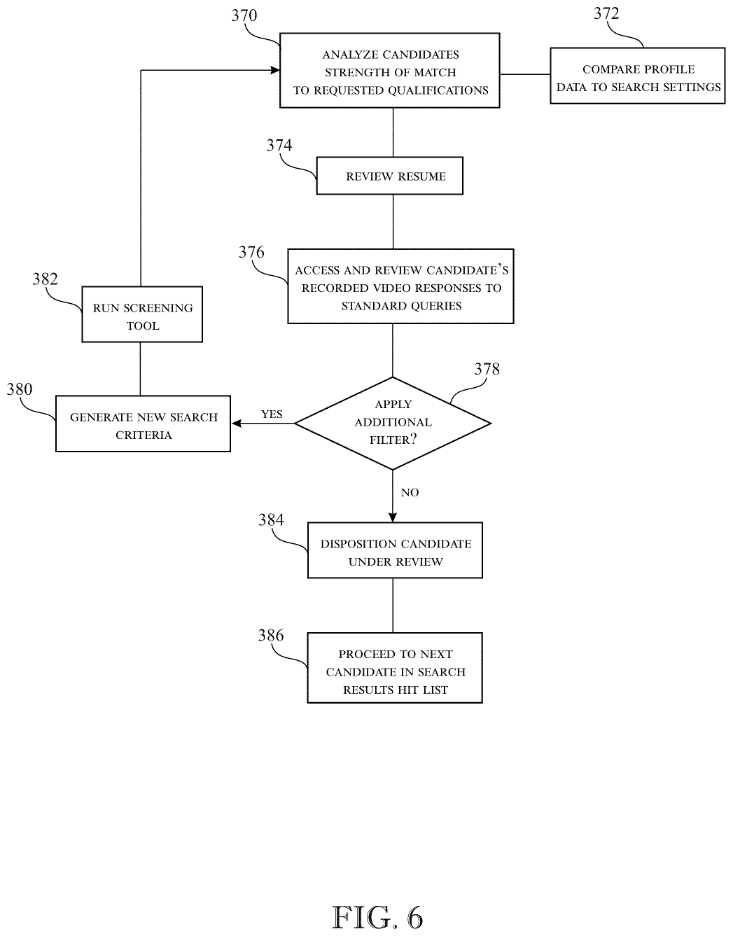

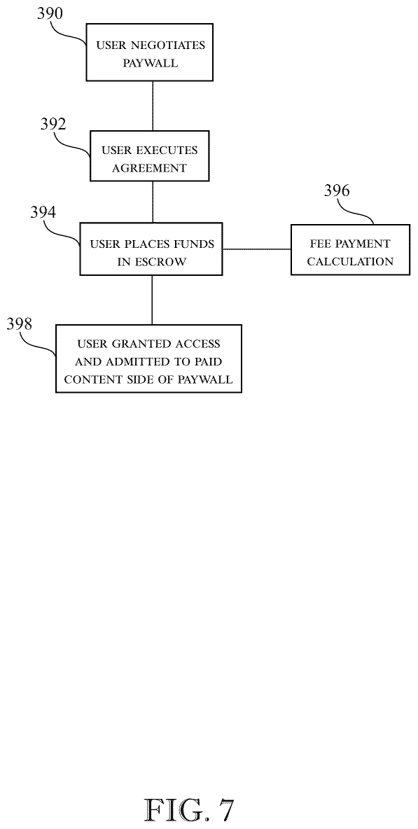

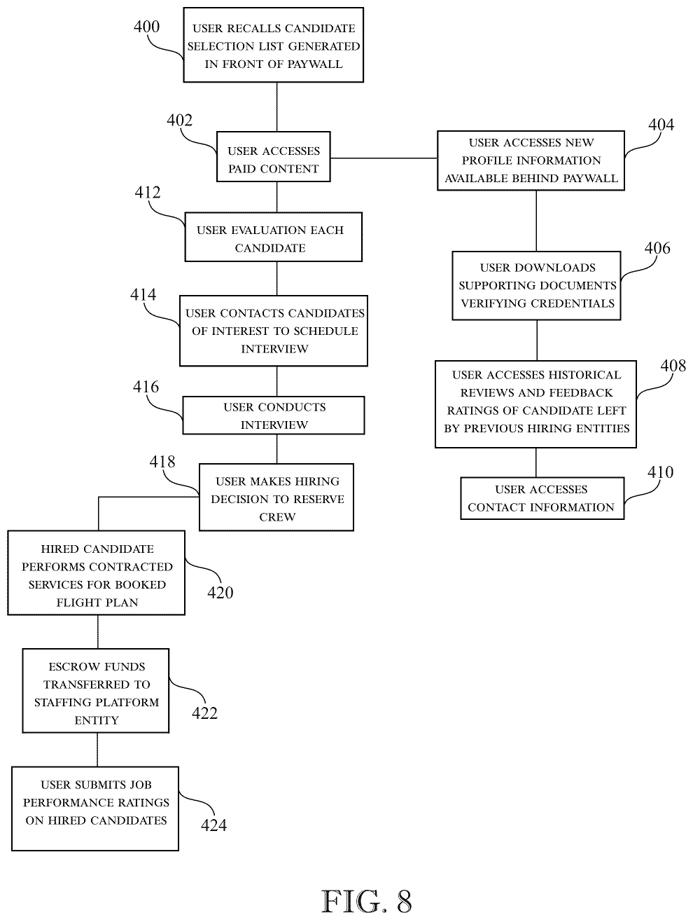

Referring again to FIG. 3, the remaining steps of process 300 (steps 304, 306, 308, 310, 312, 314) are performed by an employer-side individual seeking to staff or fill one or more vacant job positions or opportunities with one or more job applicants who have candidate profiles in the staffing personnel database 210 of cloud-based system 200 (FIG. 1). By way of overview, steps 304 and 310 are pre-paywall operations or functionalities that are elaborated in more detail in the flowcharts of FIGS. 5-6 and are implemented at least in part by subsystem 220 of FIG. 2. Moreover, step 306 relates to a paywall functionality that is elaborated in more detail in the flowchart of FIG. 7 and is implemented at least in part by subsystem 222 of FIG. 2. Additionally, steps 308, 312, and 314 are post-paywall operations or functionalities that are elaborated in more detail in the flowchart of FIG. 8 and are implemented at least in part by subsystem 224 of FIG. 2.

By way of overview, in FIG. 3, the hiring or staffing entity (user) first engages in a set of pre-paywall operations. The user makes a provisional selection of the crew based on an appraisal of job applicants (step 304). The user identifies candidates who meet, satisfy or otherwise match certain criteria representing qualifications and/or credentials. The screening process accesses free content on the job applicants, which represents a subset, portion, or partial of the full profile information available on each applicant (step 310). The user then navigates a paywall to gain access to the complete profile of the members of the provisional crew selection (step 306). The user then makes a final selection of the crew (step 308). In making this final selection, the user accesses the full profile of each selected candidate, which includes paid content now made available behind the navigated paywall (step 312). The recruitment, for example, may involve an interview stage, which is made possible by using contact information acquired from the paid content. After the interview stage, the user makes a final disposition of each candidate, resulting in the final crew membership (step 314).

Referring now to FIGS. 5-6, in conjunction with FIG. 2 (subsystem 220), the pre-paywall operations and/or functionalities (i.e., process steps 304, 310 in FIG. 3) are disclosed in greater detail. The user enters the client (employer or hiring-side) portal of the staffing service website hosted by the cloud-based server system 200 (step 330, FIG. 5). Reference will also be made, as appropriate, to FIGS. 9-21, which serve as examples of renderings of webpages produced in a web-based implementation of the present invention, in which the staffing service facility is organized and implemented as a website hosted by a server in the cloud-based system 200. The user can be any individual or entity trying to fill a job position, such as an employer, staffing agent, recruiter, private aircraft owner/operator, or any other hiring entity. In FIG. 1, the hiring entity, as user 10, can employ electronic device 102 to access the website (interactive content 108 displayed locally) via a browser-based facility 104 or an app-based facility 106. The user initially completes a registration or sign-up process to establish an account with the staffing service facility (step 332). Next, in reference to the high-level staffing process 300 (FIG. 3), the user makes a provisional selection of the crew, including flight crew and/or cabin crew (step 304). As discussed further, this provisional or pre-selection of the crew members is made on the basis of a subset of the full candidate profile, namely, the free content accessible in front of the paywall (step 310, FIG. 3). Generally, in one exemplary embodiment, the subset of the full candidate profile includes the general appearance of the candidate, multimedia content (e.g., voice memos, video memos, additional images) further distinguishing the candidate and a required display of related job credentials.

Referring to FIG. 5, the operations behind steps 304, 310 (FIG. 3) commence with the user visiting and accessing the staffing service website at the free-content side of the paywall (step 334, FIG. 5), once the account registration process is completed. The user accesses and otherwise interacts with an online flight scheduler 230 of subsystem 220 of the cloud-based server system 200, in order to build a flight plan or itinerary (step 336). The flight scheduler 230, for example, can provide a calendar that can be highlighted, marked-up or featured with a project or booking history, including overlying graphics to indicate flight status, such as past flight, flight in progress, flight coming (future or upcoming flight), and flight cancelled. For each flight, the user can provide the relevant flight plan information, including, but not limited to, the details of the flight (airport codes for each leg of trip), departure/arrival times, date(s) of travel, a tail number for the aircraft, and the status of the flight (e.g., in-progress, coming). A flight plan, for example, may refer to service for a requested charter flight. The flight booking information compiled by the user with flight scheduler 230 is effective in generating staff availability criteria, namely, a specification of the flight information for which the user/hiring entity is seeking candidates to fill crew positions on a given flight (step 338). The staff availability criteria will be used as one of the filtering options to define the minimum qualifications needed, enlisting the criteria as search parameters to perform a search to identify suitable or applicable candidates. As a preliminary step to the candidate search, the user first selects the type of staffing needed, namely, a flight crew or cabin crew selection (steps 340, 342). The user is able to repeat the staffing process 300 an unlimited number of times to find the right personnel. In one search or recruitment strategy, for example, the user can first commit to acquiring and otherwise procuring the members of the flight crew, then turn to an acquisition of the cabin crew in another search session. Alternately, an efficient and economical strategy could perform the flight crew and cabin crew recruitment process at the same time, i.e., the entire crew requirements are addressed in a single search session.

The user deploys a screening tool 232 of subsystem 220 of the cloud-based server system 200 (FIG. 2) to perform a search of the candidate profile records 212 in staffing personnel database 210 (FIG. 1). The screening tool 232 enables the user to select the candidate search parameters and/or filtering criteria (step 344), which yields search results (step 346). The search strategy applies a search or filtering operation to the candidate profile records 212 in staffing personnel database 210, employing the user-supplied search parameters/criteria as an index or key, and generates search results (step 346), which signify or represent a hit list of matching candidate profiles that satisfy the search criteria (step 348). Any means known to those skilled in the art can be used to perform the search process, including, but not limited to, a suitable search engine application. The goal of the screening process, in one form, is to make a determination regarding a job applicant's qualifications and potential job fit for a position to which they have made themselves available. The search criteria can include, but are not limited to, parameters reflecting minimum qualifications, preferred qualifications, enhanced qualifications, and/or availability for a specific flight(s) (as indicated by the staff availability criteria, generated in step 338).

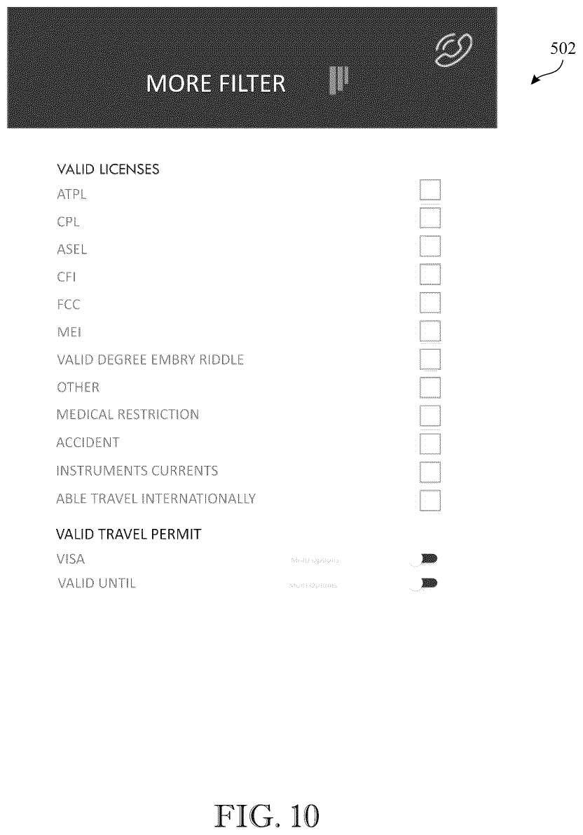

FIGS. 9 and 10 are an example of the content of a menu-driven webpage displaying the generated search results, according to a web-based implementation of the present invention. The generated search results or hit list of matching candidate profiles can be indicated in screenshot 500 of FIG. 9 as the vertical series of candidate profile pictures generally illustrated at 510. In one presentation format, the set of matching profile pictures 510 can appear on the same page as the search or filter criteria generally illustrated at 512. Any suitable format for displaying or presenting search results can be used, as known to those skilled in the art. The search criteria 512 is merely illustrative and should not be considered in limitation of the present invention. In another presentation format, the candidate profile picture 510 may include a marking, such as a frame around the picture demonstrating the current status of the crew member. For instance, if the crew-member is selected, the border is green, if the crew member does not match the search parameters the color is orange, or if the crew-member is rejected the border is red. For purposes of illustration, the search results depicted in FIGS. 9-21 refer to members of a flight crew. The qualifications can include, but are not limited to, flight experience time, valid licenses, aircraft type qualified to operate, education, valid travel permit, and salary range. As shown, an expand or show-more button (+) can be used to display or request additional filtering options, such as the information shown in the adjacent screenshot 502 (as seen on FIG. 10). The flight experience time can be displayed as a marker within a specified continuous range, indicating where the candidate qualifications fall within the preset range. The flight experience subcategories can include, but are not limited to, PIC (pilot in command), SIC (second in command), time spent in different aircraft (multi-engine, turbo prop, jet), flight distances or time of day (cross-country, night), and/or time spent in different flying or operating conditions (e.g., VFR or visual flight rules and IRF or instrument flight rules). The valid licenses subcategory can include, but is not limited to, FAA (Federal Aviation Administration), EASA (European Union Aviation Safety Agency), Class 1 Medical, ATPL (Airline Transport Pilot License), CPL (Commercial Pilot License), ASEL (Airplane Single Engine Land), CFI (Certified Flight Instructor), MEI (Multi-Engine Instructor), valid degree from Embery Riddle Aeronautical University, medical restriction, accident, instruments current, able to travel internationally. The aircraft type subcategory can include, but is not limited to, model, type rating, TT (Total Time), SIC, and PIC. The education subcategory can include, but is not limited to, place of graduation/matriculation, and year of graduation. The valid travel permit subcategory can include, but is not limited to, vaccination status (proven or documented), passport (with country of issuance and expiration date), Visa(s) (country and valid-until dates), languages spoken, and driver's license. Additional subcategories can include training school (venues and training dates), former background (prior places of employment), and hobby (e.g., standby hobby). A crew base subcategory can be added, referring to the various airport stations where commercial Pilots and Flight Attendants normally begin and end their duty periods. The crew base subcategory can elicit or reflect relevant information, such as a distance option (mileage from a flight origination) and affirmative/negative responses to certain questions (e.g., willingness to relocate, commute position).

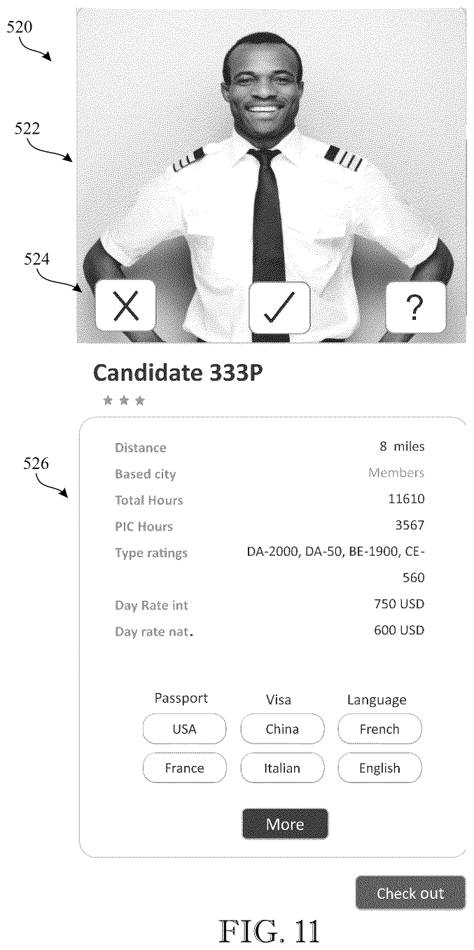

The user then proceeds to an analysis or evaluation of the applicable candidate profiles identified in the search results, which involves making a disposition of each member of the search hit list (step 350, FIG. 5). The user engages and otherwise interacts with a partial-profile access and analysis module 234 of subsystem 220 of the cloud-based server system 200 (FIG. 2) to process each one of the applicable candidate profiles. From the generated hit list 510 of applicable candidate profiles, the user can select each profile individually for further evaluation. To do this, the user can highlight, activate, or otherwise select the candidate of interest from hit list 510 (FIG. 9), such as candidate profile 514, which produces the candidate-specific content depicted generally in FIG. 11 as webpage 520 (relating to the chosen individual who is designated Candidate 333P). The applicant-specific content shown in FIG. 11 includes a picture 522 of the candidate, including a set of disposition items or selections 524 at the bottom of picture 522, and a summary of relevant candidate information generally illustrated at 526. As shown, the content 526 can include, but is not limited to, flight-related qualifications such as Distance from flight origination airport, Base city, Total Hours logged, PIC Hours logged, Type ratings, and Minimum salary requested. These qualifications might be considered primary or the minimum essential qualifications needed. Other important, but not necessarily flight-related data items and categories, can include, but are not limited to, passport (e.g., USA and France), Visa (e.g., China and Italy), and Language (e.g., French and English). These qualifications might be deemed secondary or preferred qualifications, depending on the flight and the needs of the jet charter client contracting with the staffing agency. For example, international flights might render passport and/or Visa credentials necessary or required. The applicant-specific content shown in FIG. 11 also illustrates an icon 521 that notifies the user that the candidate has previously matched with the user. In this way, the user can obviate the search process because they are aware of the candidates the user has previously hired. It should also be understood that the candidate may include one or more images on his profile.

Referring to FIG. 6, with continuing reference to FIGS. 9-12, the candidate review and evaluation step 350 (FIG. 5) is described in further detail. The user analyzes the candidate's strength of match to the requested qualifications, specifically comparing the candidate's profile data to the search settings (steps 370, 372). In FIG. 9, for example, the search criteria 512 shows various adjustable subcategory settings under the Flight Experience Total Time category (e.g., Min, PIC, SIC, Multi engine, Turbo prop). The settings use a conventional slider bar mechanism to specify the selection (numerical value) within a certain given range. In FIG. 11, the summary 526 for the chosen individual, designated candidate 333P, shows the candidate-specific values relating to the search criteria 512 of FIG. 9. Other free content is available on each candidate in the search results hit list. The user can review the candidate's resume, which was previously uploaded by the applicant during the submission process (step 324 on FIG. 4) (step 374). The user can also access and review the candidate's recorded video responses made in reply to the standard queries (step 376), which formed part of the applicant's job application submission process (steps 328, 330, 332 in FIG. 4). Additional data items from the candidate summary 526 can include, but are not limited to, the dates of expiration of the noted passport and Visa subcategories. The candidate search and evaluation process undertaken by the user and disclosed in reference to FIG. 2 (subsystem 220) and FIGS. 5-6 is performed on the free-content side of the paywall. The user consults that portion of the candidate profile deemed free content.

Accordingly, the candidate analysis made by the user in front of the paywall is considered partial, limited, and/or restricted. However, the candidate information disclosed herein as pertaining to free content should not be considered in limitation of the present invention but merely illustrative of one way to implement the combination and allocation of free content and paid content. The staffing service website can be modified or adjusted to selectively allocate job applicant information between free content and paid content. For example, the filter used by the search engine to define the search criteria can be configured to reflect what is free content versus paid content, i.e., the search engine settings define free content from candidate profiles. The assignment of applicant information to free content or paid content can be a modifiable feature of the staffing service website. It should be apparent that one skilled in the art could design a website to reflect this modification feature.

At this point in the process, at the free content side of the paywall, the user is in a position to disposition the candidate based on the evaluation. The type of disposition can depend on the confidence level placed in the evaluation. The website can provide different types of disposition options. In one form, for example, the user can reject the candidate (e.g., the X mark in the disposition section 524 of FIG. 11), accept the candidate (e.g., the check mark), or place the candidate in a crew list for further evaluation (e.g., the question mark icon). Each disposition selection can have different consequences. For example, full acceptance might reflect a decision to immediately propose hiring the candidate, without any further evaluation (e.g., an interview). A tentative commitment (the question mark) might reflect a decision to proceed with further evaluation based on information drawn from behind the paywall (e.g., contact information to schedule an interview). In another form, the user can swipe to the left to reject the candidate (i.e., select the X mark), swipe upward to accept the candidate (i.e., select the check mark), or swipe right to further evaluate the candidate (i.e., select the question mark).

Prior to candidate disposition, the user can apply an additional filtering process to modify the search criteria in an effort, for example, to expand or narrow the qualifications (step 378, FIG. 6). The user can refine or tune the search already completed, or start over and generate an entirely new set of matching results. If the user decides to initiate an additional search, the user is directed to generate and select new search criteria and then run the screening tool again, after which the evaluation process is again performed (steps 380, 382 on FIG. 6). If the user is satisfied with the search results and the evaluation process for the candidate of interest, and a disposition has been made, the user can proceed to evaluate another candidate identified in the search results hit list (steps 384, 386 on FIG. 6).

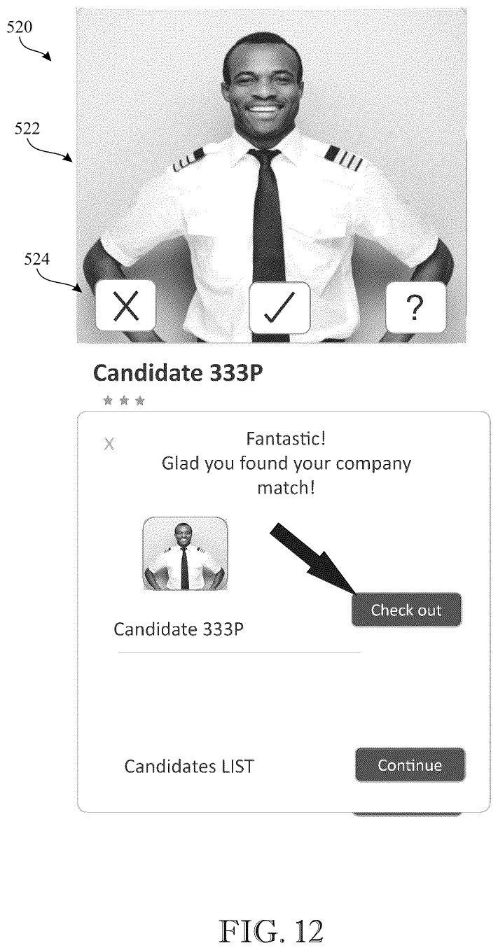

Referring again to FIG. 2 and FIG. 5, the candidate evaluation process draws to a close once a decision is made on each candidate profile in the search results hit list (step 352). In this disposition step, each member of the hit list is categorized to reflect the type or level of interest (step 354), such as rejection (e.g., the X icon in disposition section 524, FIG. 12), unconditional acceptance (e.g., the check mark, reflecting readiness to hire), and conditional acceptance pending further evaluation (e.g., the question mark, indicating a desire for more input, such as an interview). The website, in one interactive feature, is equipped with a mechanism to allow the user to apply a swiping gesture to the candidate profile picture, as a means to indicate candidate preference, hiring decision, and/or disposition (step 356). To implement this feature, an interest level designator 238 of subsystem 220 of the cloud-based server system 200 (FIG. 2) is provided in the form of appropriate software and/or hardware. For example, a swipe left rejection-activating gesture applied to the candidate profile picture will apply a red border to the picture, while a swipe right acceptance-activating gesture applied to the picture will apply a green border to the picture. The colored bordering showing the new status, indicating the individual candidate disposition, will appear in the set of pictures 510 (FIG. 9) as part of the updated search results hit list page.

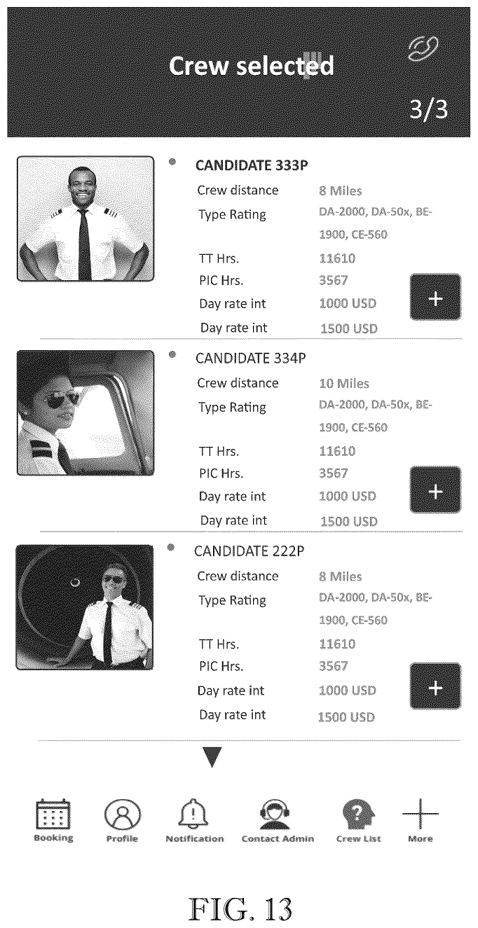

At this point in the process, a crew list compilation feature 236 of subsystem 220 of the cloud-based server system 200 (FIG. 2) assembles the complete set of candidate dispositions made by the user, creating a provisional crew selection (step 358, FIG. 5). The provisional crew, for example, includes members receiving unconditional and conditional acceptance during the evaluation process. The crew selection is deemed provisional since it is made on a tentative or contingent basis, pending the outcome of a further evaluation based on information acquired behind the paywall. The user can now decide to reserve the crew, drawn from the provisional crew selection, and proceed to the second or final stage of the recruitment and staffing process available behind the paywall (steps 360, 362). FIG. 13 is a webpage showing the provisional crew selection, including a summary of each candidate and their profile picture, according to a web-based implementation of the present invention. The webpage is furnished with a clickable crew-reservation link designated Reserve your crew, which if activated takes the user to the paywall. Any format can be used to display and otherwise present the provisional crew selection in advance of the paywall-enabled reservation process. In one exemplary embodiment, a user may select a plurality of pre-selected candidates, e.g., 20 candidates. From those candidates, the user must dwindle down the candidates to a pre-determined number, e.g., no less than 3. The selection process can be done by removing unwanted pre-selected candidates by selecting on the minus icon. Pre-selected candidates that are still of interest may be retained in selection by clicking on the plus icon, as shown in FIG. 13.

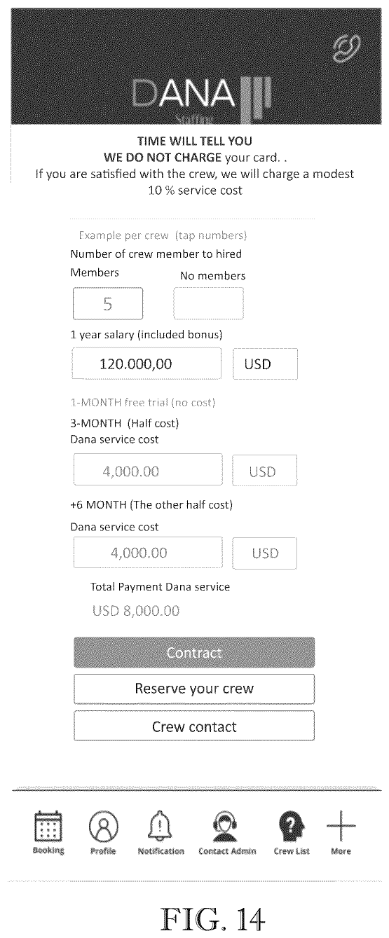

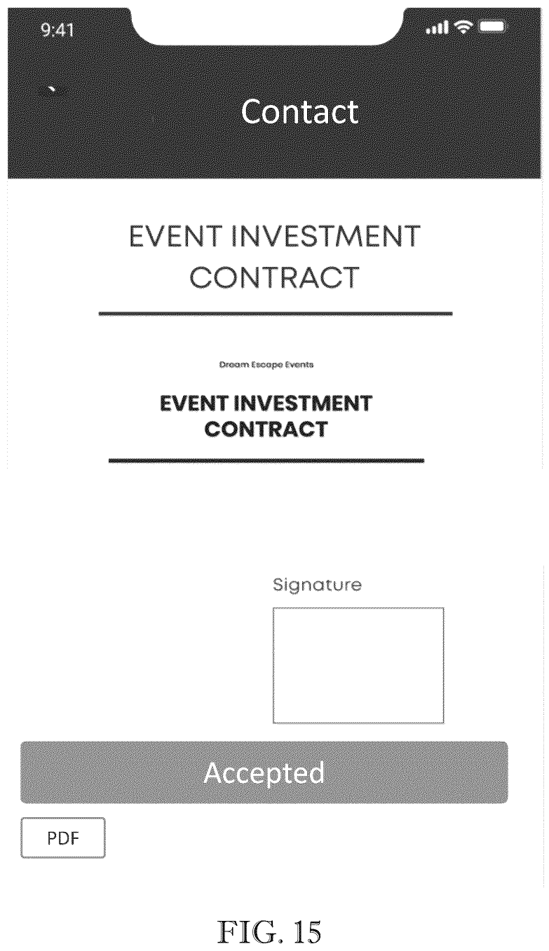

Referring again to the high-level staffing process shown in FIG. 3, the user next navigates the paywall (step 306). Reference is additionally made to FIGS. 2, 7, 14, and 15, for further elaboration of this process step. The paywall subsystem 222 of subsystems 204 of the cloud-based server system 200 (FIGS. 1 and 2) implements, at least in part, the paywall navigation process shown in FIG. 7. The user engages the paywall processor 240 of subsystem 222 of the cloud-based server system 200 (FIG. 2), in order to perform negotiation of the paywall (step 390, FIG. 7). The user interacts with a contract execution module 242 of subsystem 222 (FIG. 2) to facilitate the execution of an agreement with the proprietor of the staffing service (e.g., website owner) (step 392). This contract (FIG. 15), at least in part, stipulates that the user/staffing entity will not misuse or misappropriate the paid content behind the paywall to complete the hiring process and engage performance of services by the hired crew, without crediting the staffing service in a follow-up by reporting performance and authorizing payment of the escrowed service fee. A feature of the paywall is that the user places funds in escrow (step 394), which corresponds to the service fee payable in the event that the pre-selected or provisional crew is hired and performs the desired flight services. The fee constitutes an upfront, financial commitment on the part of the user and acts in part to incentivize the user to exercise the utmost due diligence in reviewing and making final decisions about the pre-selected set of candidates, to fill out the crew positions or vacancies. The escrow amount is determined by a staffing level compensation calculator 244 of subsystem 222 of the cloud-based server system 200 (FIG. 2), which first determines the compensation due to each member of the provisional crew selection, if the members are hired and perform the requested flight services. The salary data on each candidate is available as part of the free content portion of the candidate profile. Once this compensation amount is determined, a fee payment amount is calculated, which functions as the fee or commission owed to the staffing service website proprietor (step 396), such as a percentage of overall compensation. Any fee calculation strategy can be used to determine the fee amount. For example, a higher commission might apply with flight crew and a comparatively lower commission with cabin crew. The user interacts with a payment terminal 246 to deposit the appropriate fee amount into an escrow fund depository 248 of subsystem 222 of the cloud-based server system 200 (FIG. 2). At this point, the terms of the paywall have been successfully negotiated and the user is now admitted behind the paywall and granted access to paid content (step 398). FIG. 14 shows an illustrative webpage depicting the compensation calculation portion and the contract execution portion of the paywall process. The payment or compensation section shows, for example, salary amounts and periods of service/hire, in addition to the corresponding calculated commission or fee. In one configuration, the authorized paid content accessible behind the paywall is only for the crew provisionally selected by the user on the free-content side of the paywall, since calculation of the escrow amount is made on the basis of membership in the provisional crew selection, and is determined by the salary demands of the selected candidates and the terms of engagement (e.g., length of anticipated service).

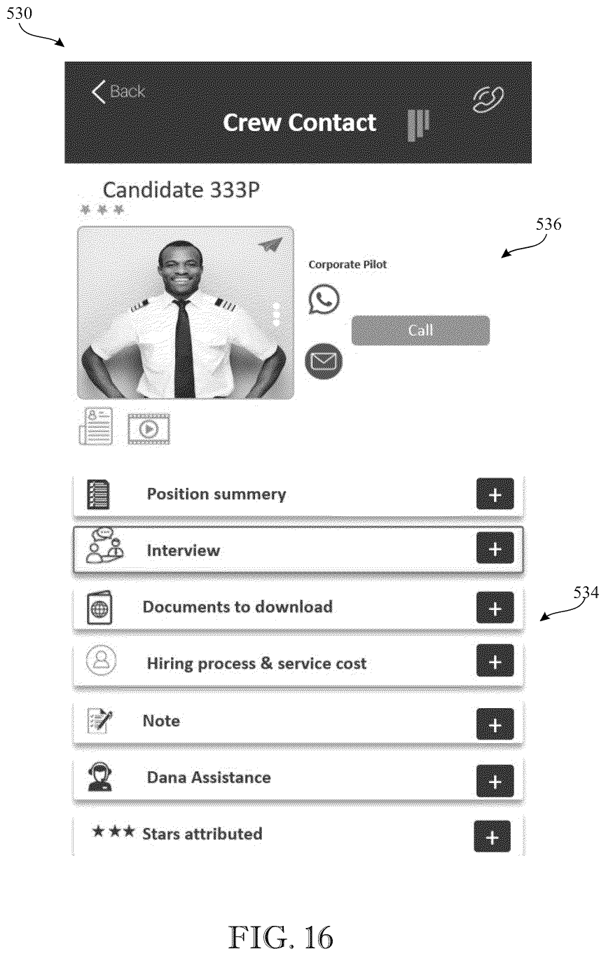

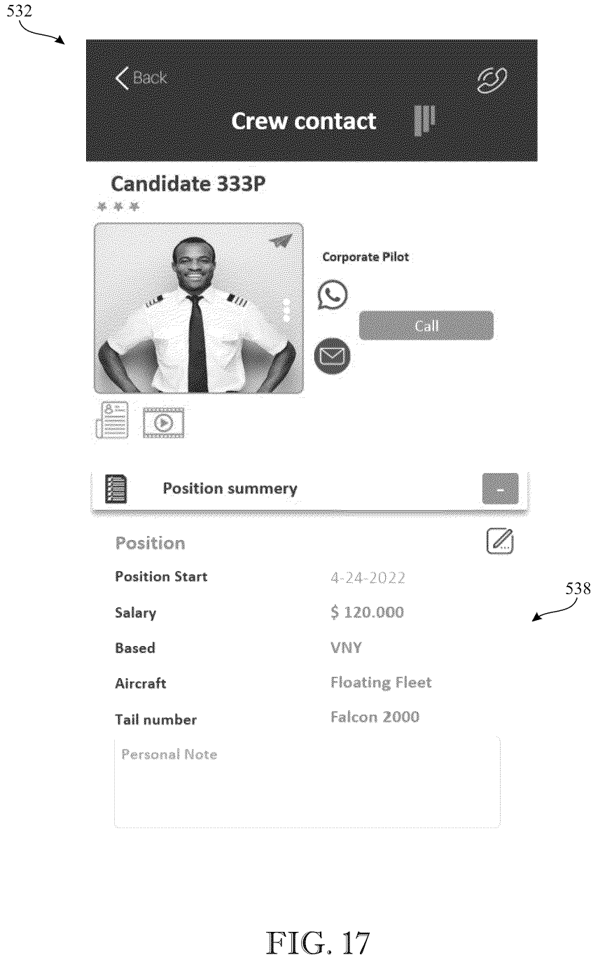

Referring again to the high-level staffing process shown in FIG. 3, the user next makes a final selection of the crew (step 308), which entails access to paid content behind the paywall that provides access to the full profile of each candidate (step 312) and an eventual final disposition of each candidate after further evaluation, such as an interview (step 314). Reference is additionally made to FIGS. 2, 8, and 16-21, for further elaboration of post-paywall process steps. Behind the paywall section of the staffing service website, the user recalls the provisionally-made candidate selection list generated on the free-content side of the paywall (step 400). A full-profile access and analysis module 250 of subsystems 204 of the cloud-based server system 200 (FIGS. 1 and 2) is configured to grant the user access to the paid content of the selected candidates (step 402) and present the user with the opportunity to perform a further evaluation of the candidates on the basis of this newly-available candidate profile information (i.e., paid content) (step 412). In particular, the user accesses the new profile information available behind the paywall (step 404). This paid-content portion of the candidate profile includes, but is not limited to, candidate contact information (step 410), documents that support or otherwise corroborate asserted credentials (step 406), and historical reviews and feedback ratings of the candidate made by previous hiring entities (step 408). The supporting documents can relate to credentials such as passport, Visa, and various certifications. FIGS. 16 and 17 show illustrative webpages, including sections 530 and 532, located behind the paywall, which depicts a menu of offerings 534 on one of the candidates in the provisional crew selection. The menu 534, for example, can include subcategories such as Position summary (detailed further in section 532 as format 538 by using the expand key), Interview, Documents to download, Hiring process & service cost, Note, and Stars attributed (which corresponds to the review and feedback ratings). The candidate's contact information 536 is also now available.

An interview scheduler 254 of subsystems 204 of the cloud-based server system 200 (FIGS. 1 and 2) supports an interview functionality. The interview scheduler 254 works in cooperation with a messaging unit 252 of subsystems 204 (FIG. 2) to make contact with the candidate and arrange an interview (step 414), proposing various dates and times and mode of interview (e.g., video, phone, in-person). In one exemplary embodiment, the messaging unit 252 sends an electronic message to the candidate. The electronic message may comprise but is not limited to an email, SMS, iMessage, direct message on one or more social media platforms (e.g., Twitter®, Instagram®), or the like. The messaging unit 252 can facilitate communication using one of the means of contact 536 provided by the candidate. If virtual, the interview can be conducted using any video conferencing technology or phone service application (e.g., VoIP), as implemented by a telecommunication service module 256 of subsystems 204 (FIG. 2). If the candidate is interested and an interview is scheduled, the user conducts the interview (step 416).

In the final part of the staffing process, the user makes a final disposition on each candidate, following the interview, if one is held. In particular, the user makes a hiring decision on each candidate in order to determine the final composition of the crew and to reserve the crew (step 418). A reservation and hiring module 258 of subsystems 204 of the cloud-based server system 200 (FIG. 2) is configured to support the hiring process. The reservation and hiring module 258 can provide an update or notification on the hiring status of each candidate selected for hire (e.g., successful hire, hiring in progress, hiring unsuccessful), and can show the compensation amount allocable to the hire or projected hire. During hiring process, the hiring the server system 200 sends a notification alert to the selected crew members to accept or deny the offer or interview.

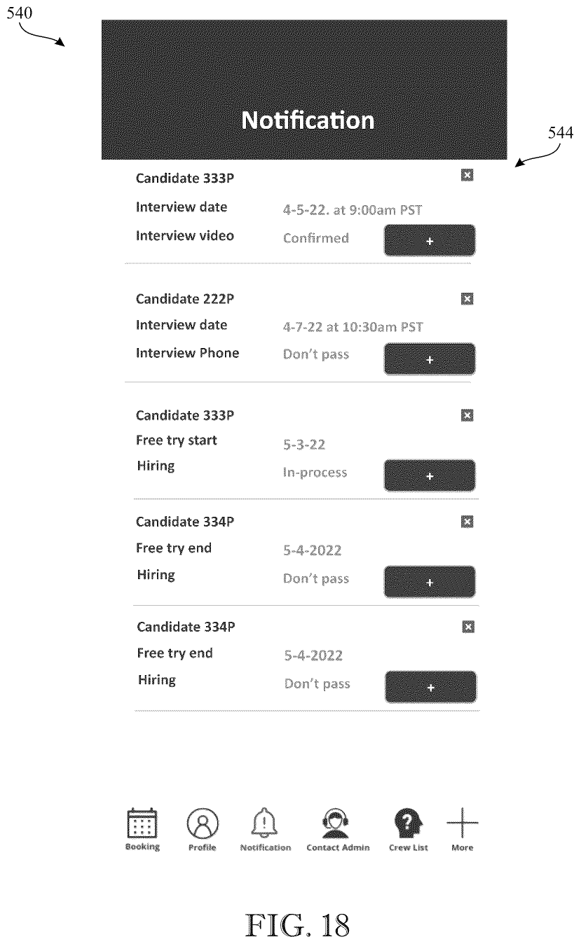

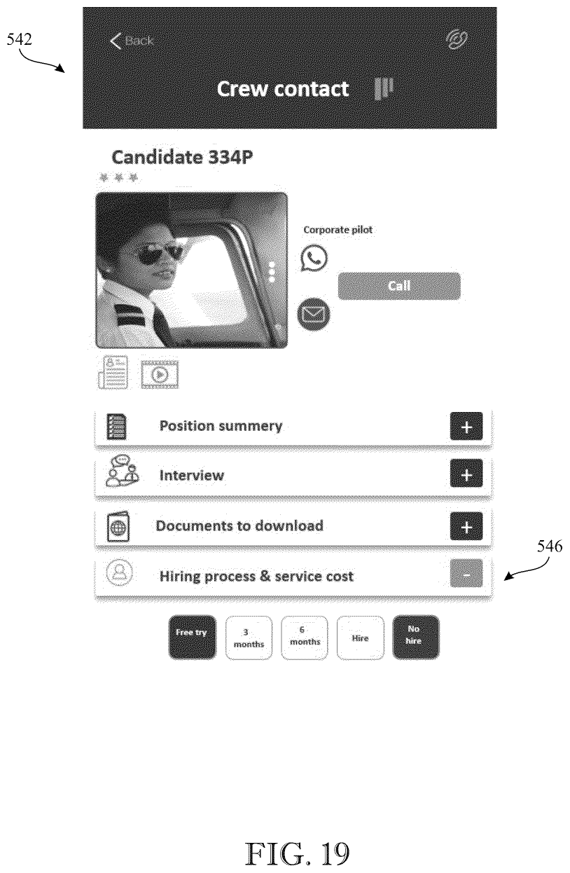

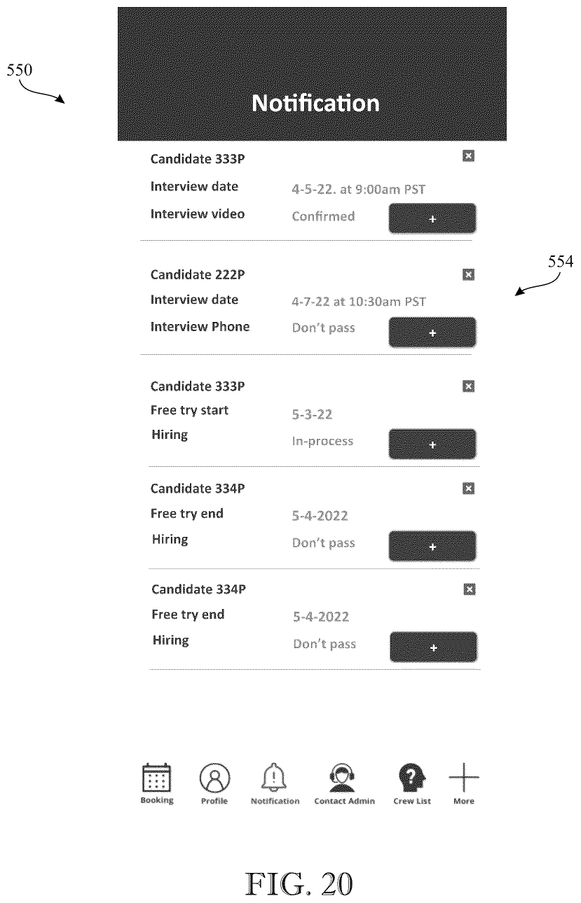

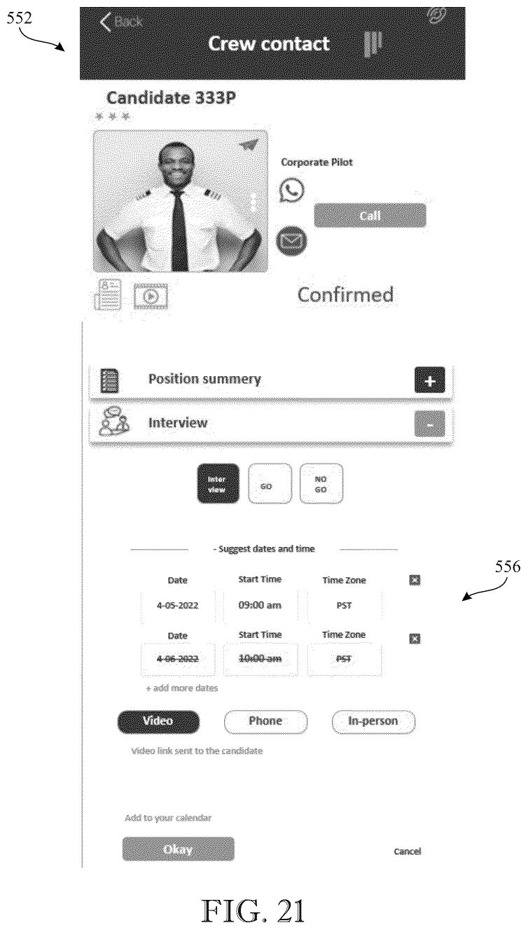

FIGS. 18 and 19 show illustrative webpages, including sections 540 and 542, located behind the paywall, which depicts a Notification section generally illustrated at 544 to provide updates on each candidate, including interview status and hiring status. By activating a link in the candidate profile displayed in the Notification section 544, the user requests candidate-specific detail 546 on the hiring process to be retrieved and displayed (webpage section 542). FIGS. 20 and 21 show illustrative webpages, including sections 550 and 552, located behind the paywall, which depicts Notification section 554 and the selection of one of the candidates to get details 556 on the interview status.

At this point, the staffing operations are effectively completed. The crew has been assembled and hired. All that is left is performance of the requested flight services, as either a member of the flight crew or cabin crew. Each candidate hired by the staffing process performs the contracted services in relation to the scheduled or booked flight plan or itinerary (in the case of a chartered flight as a freelance or independent contractor) or the agreed-upon period of employment (in the case of part-time or full-time employment) (step 420). Once performance occurs, the escrow funds are transferred to the staffing platform entity (e.g., staffing website owner) (step 422). It is possible that some escrow funds will be returned or refunded to the extent any of the provisional crew members, on the basis of which the escrow amount was calculated, were not ultimately hired. The user (hiring entity) can submit job performance ratings on the hired candidates, reflecting various aspects of performance, including, but not limited to, interview impressions (e.g., arrive on time), personality impressions (e.g., respectful), feedback from other crew members, feedback from client (e.g., the passengers of the chartered flight), and understanding of client's privacy.

The present invention provides a customized and personalized staffing service in the recruitment, evaluation, and selection of candidates to fill positions as members of the flight crew and cabin crew. The custom features enable a hiring entity to access and evaluate a wider range of candidate material than conventionally available in typical hiring situations. For instance, the candidate may provide material that grants a staffing agent the ability to see and hear how the candidate speaks, looks, or otherwise comports himself before seeking a more formal interview. A staffing agent or hiring entity has access to a two-tiered, paywall-regulated, repository of candidate profile information. The user can access free content on job applicants to perform a search to identify a pre-selection of qualified candidates, based on a specification of required and/or necessary qualifications in addition to preferred qualifications. This screening process is performed asynchronously, as the job applicants have previously submitted their information, which is then compiled into an individual candidate profile. The negotiation of a paywall grants access to paid content, which in combination with the free content, constitutes the full profile of the candidate. The paid content facilitates synchronous communication with the candidate, since contact information forms part of the paid content.

The website supporting the staffing service provides the profile information in a multimedia experience or presentation, including text or document-style information (e.g., resume), credentialing data (e.g., licensing and certification documents), video clips, and interactive graphical formats. The video feature, for example, allows the user to review video responses the candidate submits in reply to various queries. The video clips allow potential employers to view candidates, hear them talk about their work experience and about themselves, and why they are a good fit for a particular position. Unlike a strictly record-based evaluation (i.e., review paperwork on a candidate), a recruitment process that consults candidate-made video clips is more dynamic and insightful, since it offers a glimpse into the personality, affect, interaction style, demeanor, and presence of a candidate, all qualities that a client for a chartered flight might find important and valuable. The video responses are not a substitute for an in-person interview, but they do offer a way to evaluate the personal attributes of a candidate in a way that might be considered more natural than what can be drawn from a formal interview. The search feature of the staffing service provides a robust filter to screen the available job applicants with a wide range of diverse and finely tuned specifications, parameters, attributes, and criteria. The staffing service enables a thorough screening and vetting of candidates to identify applicants of the highest quality who exhibit a high level of fitness and match to the highly customized and personalized requirements of the client. The screening process may also take into consideration the geographical location of the candidates. For instance, the user can search for candidates that fit certain criteria and are within a chosen geographical threshold. Moreover, as is understood in the art, a candidate may specify their availability on an accessible calendar to notify the user of their availability for an interview and their geolocation for the interview.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

In one exemplary embodiment, an employer may have the option to select a monthly subscription package to gain access to the decrypted information on crew members without having to go through the paywall to gain access to the encrypted information and schedule interviews with the candidates.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A computer-implemented method, the method comprising:
using a digital platform stored in a computer-readable memory and executed on at least one processor with access to one or more databases;
determining receipt of a plurality of candidate profile information in a non-standardized format that is storable on the database;
automatically, by way of an encryption module of the digital platform, standardizing and encrypting a portion of the candidate's profile information and maintaining a portion of the candidate's profile information standardized but decrypted;
assigning, by way of a variable assignation module of the digital platform, the plurality of candidate profiles a first layer of search criteria variables corresponding to the set of decrypted profile information and a second layer of search criteria variables corresponding to the set of encrypted profile information;
generating search results of first candidate profiles satisfying the first layer of search criteria variables in a standardized format when searched;
determining a first crew selection based on a first evaluation, wherein the evaluation is performed only with the decrypted information;
utilizing a gesture to select first candidates from the plurality of candidate profiles;
navigating a paywall;
automatically, by way of the digital platform, decrypting the encrypted profile information after navigating the paywall; and
determining a second crew selection based on a second evaluation based.

2. The computer-implemented method of claim 1, wherein the candidate profile information that is decrypted comprises a digital resume and a digital multi-media file.

3. The computer-implemented method of claim 2, wherein the digital multi-media file comprises a candidate's video recording responding to a set of preexisting questions.

4. The computer-implemented method of claim 1, wherein the candidate profile information that is encrypted comprises a candidate's contact information and other candidate related information.

5. The computer-implemented method of claim 1, wherein the second layer of search criteria variables are searchable only after navigating the paywall.

6. The computer-implemented method of claim 1, wherein making the first crew selection is a provisional selection contingent on a further evaluation based on paid content comprising the encrypted profile information behind the paywall.

7. The computer-implemented method of claim 4, wherein the other candidate related information comprises the candidate's geographical location, credentials, or availability.

8. The computer-implemented method of claim 1, wherein the navigation of the paywall includes the digital platform calculating a fee based on a projected compensation value to one or more members in the first crew selection based upon future performance of a job under consideration.

9. The computer-implemented method of claim 8, wherein navigation of the paywall further includes depositing an amount in escrow reflecting at least the calculated fee.

10. The computer-implemented method of claim 1, wherein navigation of the paywall further includes executing a covenant.

11. The computer-implemented method of claim 1, wherein the second evaluation includes contacting at least one member in the first crew selection using contact information contained in the decrypted profile information and scheduling an interview with the contacted member.

12. The computer-implemented method of claim 1, further comprising the step of executing a transaction involving withdrawal and/or transfer of funds from an escrow account created during the navigation of the paywall in response to fulfillment of a job obligation by one or more crew members in the second crew selection.

13. The computer-implemented method of claim 1, wherein the gesture comprises a swiping gesture in a direction on an interface, the direction swiped corresponding with disposition of the first crew selection.

14. The computer-implemented method of claim 1, wherein the digital platform is provided in a mobile application accessible through an electronic device.

15. A computer-implemented method, the method comprising:
providing an electronic device;
accessing via the electronic device a digital platform stored in a computer-readable memory and executed on at least one processor with access to one or more databases;
wherein the electronic device access the digital platform via a network;
determining, by way of the digital platform, receipt of a plurality of candidate profile information in a non-standardized format that is storable on a database inputted through the electronic device;
automatically, by way of an encryption module of the digital platform, encrypting a portion of the candidate's profile information and maintaining a portion of the candidate's profile information decrypted;
assigning, by way of a variable assignation module of the digital platform, the plurality of candidate profiles a first layer of search criteria variables corresponding to the set of decrypted profile information and a second layer of search criteria variables corresponding to the set of encrypted profile information;
generating, by way of the digital platform, search results of first candidate profiles satisfying the first layer of search criteria variables in a standardized format when searched by a user on a second electronic device having access to the digital platform;
determining, by way of the user using the second electronic device interacting with the digital platform, a first crew selection based on a first evaluation, wherein the evaluation is performed with only the decrypted information,
wherein the user utilizes one or more gestures to select first candidates from the plurality of candidate profiles;
navigating, by way of the user using the second electronic device interacting with the digital platform, a paywall;
automatically, by way of the digital platform, decrypting the encrypted profile information for the user using the second electronic device after navigating the paywall; and
determining, by way of the user using the second electronic device interacting with the digital platform, a second crew selection based on a second evaluation based.

16. The computer-implemented method of claim 15, wherein the one or more gestures comprise a swiping gesture in a direction on an interface of the second electronic device, the direction swiped corresponding with disposition of the first crew selection.

17. The computer-implemented method of claim 15, wherein the navigation of the paywall includes the digital platform calculating a fee based on a projected compensation value to one or more members in the first crew selection based upon future performance of a job under consideration and depositing an amount in escrow reflecting at least the calculated fee.

18. The computer-implemented method of claim 15, wherein the candidate profile information that is decrypted comprises a digital resume and a digital multi-media file.

19. The computer-implemented method of claim 15, wherein the candidate profile information that is encrypted comprises a candidate's contact information and the candidate's geographical location, credentials, or availability.

20. A computer-implemented method, the method comprising:
providing an electronic device;
accessing via the electronic device a digital platform stored in a computer-readable memory and executed on at least one processor with access to one or more databases;
wherein the electronic device access the digital platform via a network;
determining, by way of the digital platform, receipt of a plurality of candidate profile information in a non-standardized format that is storable on a database inputted through the electronic device;
automatically, by way of an encryption module of the digital platform, encrypting a portion of the candidate's profile information and maintaining a portion of the candidate's profile information decrypted;
assigning, by way of a variable assignation module of the digital platform, the plurality of candidate profiles a first layer of search criteria variables corresponding to the set of decrypted profile information and a second layer of search criteria variables corresponding to the set of encrypted profile information;
generating, by way of the digital platform, search results of first candidate profiles satisfying the first layer of search criteria variables in a standardized format when searched by a user on a second electronic device having access to the digital platform;
determining, by way of the user using the second electronic device interacting with the digital platform, a first crew selection based on a first evaluation, wherein the evaluation is performed with only the decrypted information,
wherein the user utilizes one or more gestures to select first candidates from the plurality of candidate profiles;
navigating, by way of the user using the second electronic device interacting with the digital platform, a paywall;
automatically, by way of the digital platform, decrypting the encrypted profile information for the user using the second electronic device after navigating the paywall;
determining, by way of the user using the second electronic device interacting with the digital platform, a second crew selection based on a second evaluation based; and
executing, by way of the digital platform in communication with a third party financial institution, a transaction involving withdrawal and/or transfer of funds from an escrow account created during the navigation of the paywall in response to fulfillment of a job obligation by one or more crew members in the second crew selection.
